(19) United States
(12) Patent Application Publication
(10) Pub. No.: US 2024/0077600 A1
(43) Pub. Date: Mar. 7, 2024

(54) OCCUPANT DETECTION DEVICE AND OCCUPANT DETECTION METHOD

(71) Applicant: Mitsubishi Electric Corporation, Tokyo (JP)

(72) Inventors: Naoya BABA, Tokyo (JP); Takumi TAKEI, Tokyo (JP)

(73) Assignee: Mitsubishi Electric Corporation, Tokyo (JP)

(21) Appl. No.: 18/272,901

(22) PCT Filed: Feb. 24, 2021
(86) PCT No.: PCT/JP2021/006720

§ 371 Date: Jul. 18, 2023

(51) Int. Cl. G01S 13/56; G01S 7/41

(52) U.S. Cl. CPC G01S 13/56; G01S 7/411

(57) ABSTRACT

An occupant detection device includes: an occupant detection unit to output detection results about occupants, each of the detection results being detected using an electric wave and being about a corresponding one of seat positions of the occupants; an output determination unit to output the detection results in accordance with the vibration amount of the vehicle; a storage control unit to store the detection results while linking the detection results with the seat positions; and a movement detection unit to detect a movement as to each occupant detected using means other than an electric wave. When the movement detection unit detects a movement of an occupant in a state where no detection result is outputted from the output determination unit, the storage control unit corrects a link between a detection result and a seat position which are stored.

### TECHNICAL FIELD

The present disclosure relates to an occupant detection device for and an occupant detection method of detecting an occupant riding in a vehicle.

### BACKGROUND ART

Conventionally, in a technique of detecting an occupant riding in a vehicle using an electric wave sensor, there is a case in which erroneous detection occurs because of vibrations.

To cope with this, Patent Literature 1 discloses an occupant detection device that prevents erroneous detection caused by vibrations.

The occupant detection device of Patent Literature 1 estimates that, when the vehicle speed V of the vehicle becomes greater than or equal to a vehicle speed threshold Vth, a vibration occurs in each occupant as the vehicle travels, and raises an intensity threshold Sth used for detecting an occupant to an intensity threshold Sth′, thereby reducing the sensitivity of the detection using an electric wave and preventing erroneous detection.

### CITATION LIST

### Patent Literature

Patent Literature 1: JP 2017-181225 A

### SUMMARY OF INVENTION

### Technical Problem

However, a problem with the occupant detection device of Patent Literature 1 is that an occupant detection result using an electric wave cannot be outputted in a state where vibrations occur. Even though an occupant detection result acquired immediately before the occurrence of vibrations is going to be used, the occupant detection result acquired immediately before the occurrence of vibrations cannot be used because it may not indicate an actual state when an occupant moves from one seat to another in a state where vibrations occur.

It is an object of the present disclosure to provide an occupant detection device that can output an occupant detection result with few errors even when an occupant moves from one seat to another in a state where vibrations occur.

### Solution to Problem

An occupant detection device according to the present disclosure detects one or more occupants riding in a vehicle, and includes: an occupant detection unit to output one or more detection results about the respective one or more occupants, each of the one or more detection results being detected using an electric wave, each of the one or more detection results being about a corresponding one of seat positions of the one or more occupants; an output determination unit to determine whether to adopt or reject the one or more detection results provided by the occupant detection unit in accordance with a vibration amount of the vehicle, and to, when the one or more detection results are adopted, output the one or more detection results; a storage control unit to cause a storage unit to store the one or more detection results outputted by the output determination unit while linking the one or more detection results with the respective seat positions in the vehicle, and to then output the one or more detection results; and a movement detection unit to detect a movement as to each of the one or more occupants detected using a means other than an electric wave, and to output pieces of position information about the respective one or more occupants. When the movement detection unit detects a movement of one of the one or more occupants in a state where no detection result is outputted from the output determination unit, the storage control unit corrects, using a corresponding one of the pieces of position information about the respective one or more occupants, a link between a corresponding one of the one or more detection results and a corresponding one of the seat positions which are stored in the storage unit, and then outputs corrected information indicating both the one or more detection results and the seat positions.

### Advantageous Effects of Invention

According to the present disclosure, because the occupant detection device is configured as above, there is provided an advantage of being able to provide an occupant detection device that outputs an occupant detection result with few errors even when an occupant moves from one seat to another in a state where vibrations occur.

### BRIEF DESCRIPTION OF DRAWINGS

FIG. 1 is a diagram showing the configuration of an occupant detection system including an occupant detection device according to Embodiment 1;

FIG. 2 is a view explaining an example of a detection method which is based on an electric wave sensor in the occupant detection system;

FIG. 3 is a table explaining an example of pieces of information contained in occupant detection results in an occupant detection unit of the occupant detection device;

FIGS. 4A and 4B are tables each showing an example of pieces of seat information and pieces of occupant identification information in the occupant detection device;

FIGS. 5A and 5B are tables explaining an example of the correction of occupant detection information by the occupant detection device;

FIGS. 6A and 6B are diagrams each showing an example of the hardware configuration of the occupant detection system including the occupant detection device;

FIG. 7 is a flowchart showing the processing performed in the occupant detection device;

FIG. 8 is a diagram showing the configuration of an occupant detection system according to Embodiment 2;

FIG. 9 is a table explaining an example of a degree of vibration influence for each of the types of occupant detection results, and a corrected vibration amount after correction which is corrected using the degree of the influence;

FIG. 10 shows tables explaining an example of correcting the degrees of reliability of occupant detection results using degrees of vibration influence;

FIG. 11 is a flowchart showing the processing performed in an occupant detection device according to Embodiment 2; and

FIG. 12 is a flowchart showing a detailed example of the processing performed in the occupant detection device according to Embodiment 2.

### DESCRIPTION OF EMBODIMENTS

Hereinafter, in order to explain the present disclosure in greater detail, embodiments of the present disclosure will be explained with reference to the accompanying drawings.

### Embodiment 1

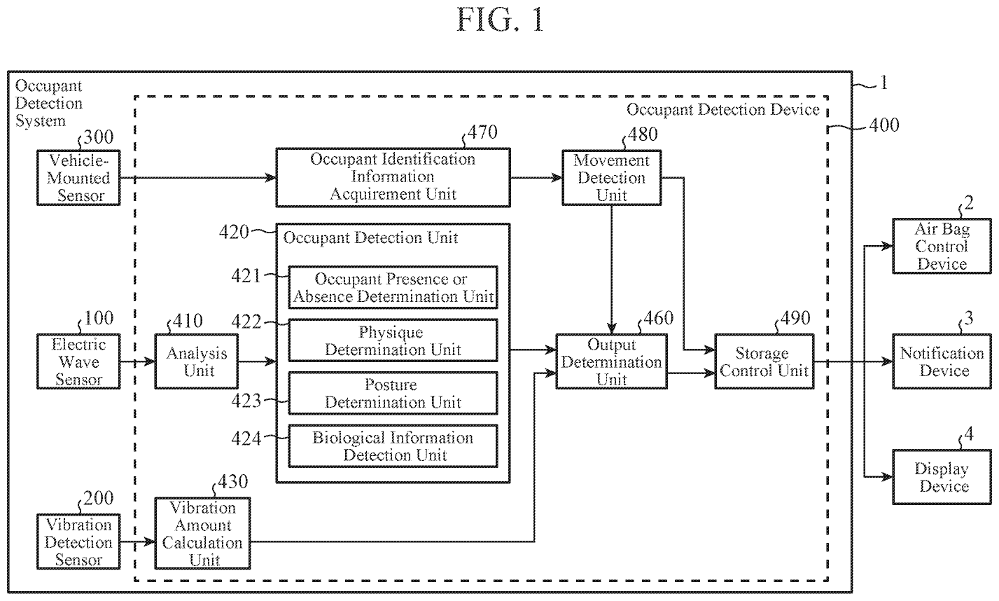

An occupant detection device according to Embodiment 1 and an occupant detection system including this occupant detection device will be explained using FIGS. 1 to 7.

FIG. 1 is a diagram showing the configuration of the occupant detection system 1 including the occupant detection device 400 according to Embodiment 1.

The occupant detection system 1 detects an occupant riding in a vehicle and outputs a detection result to pieces of vehicle-mounted equipment. The occupant should just be one of living things including human beings and animals.

The occupant detection system 1 and each of the pieces of vehicle-mounted equipment are connected in such a way as to be able to communicate with each other.

The pieces of vehicle-mounted equipment are, for example, an air bag control device 2, a notification device 3, and a display device 4.

When acquiring a detection result from the occupant detection system 1, the air bag control device 2 controls an airbag using the detection result.

When acquiring a detection result from the occupant detection system 1, the notification device 3 generates information to be notified to an occupant using the detection result, and notifies the occupant of the information.

When acquiring a detection result from the occupant detection system 1, the display device 4 generates information to be displayed using the detection result, and displays the information.

In the present disclosure, the pieces of vehicle-mounted equipment should just acquire a detection result from the occupant detection system 1 and use the detection result for processing, and are not limited to the above-mentioned examples.

The occupant detection system 1 shown in FIG. 1 includes an electric wave sensor 100, a vibration detection sensor 200, a vehicle-mounted sensor 300, and the occupant detection device 400.

The electric wave sensor 100 transmits and receives an electric wave.

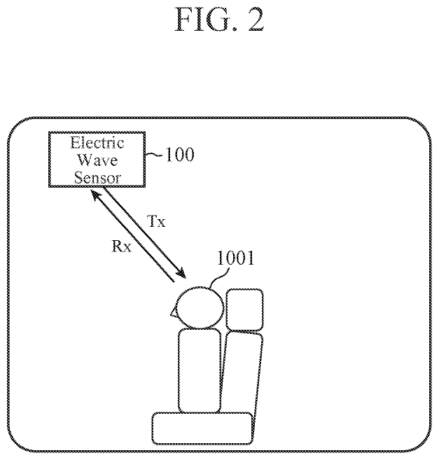

FIG. 2 is a view explaining an example of a detection method which is based on the electric wave sensor 100 in the occupant detection system 1.

The electric wave sensor 100 is mounted, for example, close to the ceiling of the vehicle, as shown in FIG. 2. The electric wave sensor 100 outputs, to an analysis unit 410 of the occupant detection device 400, both signals of a transmission wave Tx which is transmitted toward a seat in the vehicle cabin, and a received wave Rx which is caused by the reflection of the transmission wave Tx by a detection target 1001.

The position of the electric wave sensor 100 is not limited to the installation position in the example shown in FIG. 2, and the electric wave sensor 100 should just be disposed at a position where the electric wave sensor 100 can appropriately transmit the transmission wave Tx toward the detection target 1001 and receive the received wave Rx from the detection target 1001.

In the present disclosure, the electric wave sensor 100 is also referred to as a first sensor.

The vibration detection sensor 200 shown in FIG. 1 includes, for example, a gyro sensor, and detects rotation angular speeds per unit time in three axes: a pitch axis, a roll axis, and a yaw axis. For example, when the vehicle travels a bumpy road, the angular speed in the pitch axis which is a forward and backward rotation becomes large. Using this angular speed, a vibration amount calculation unit 430 which will be mentioned later can calculate a vibration amount.

The vibration detection sensor 200 is not limited to a gyro sensor, and should just be a sensor that can acquire a signal which makes it possible to detect or estimate vibrations of the vehicle, such as a signal indicating acceleration detected by an acceleration sensor, a signal indicating the speed of the vehicle detected by an acceleration sensor, or a signal indicating a pressure change detected by a seating pressure sensor.

The vehicle-mounted sensor 300 shown in FIG. 1 detects an occupant by means other than the electric wave sensor 100. The vehicle-mounted sensor 300 is constituted by, for example, an image capture device such as a near-infrared camera or a visible light camera. As an alternative, the vehicle-mounted sensor 300 is constituted by, for example, a sound collection device such as an array microphone or a directional microphone mounted for each seat. As an alternative, the vehicle-mounted sensor is constituted by, for example, a seating pressure sensor. The vehicle-mounted sensor 300 should just be a sensor that can acquire information from which the position of an occupant and features which enable identification of the occupant can be detected.

In the present disclosure, the vehicle-mounted sensor 300 is also referred to as a second sensor.

The occupant detection device 400 shown in FIG. 1 receives the signals outputted from the electric wave sensor 100, the signal outputted from the vibration detection sensor 200, and a signal outputted from the vehicle-mounted sensor 300, and outputs detection results (also referred to as “occupant detection results” hereinafter) including the presence or absence of an occupant, the physique of the occupant, the posture of the occupant, and biological information about the occupant to the pieces of vehicle-mounted equipment described above.

The occupant detection device includes the analysis unit 410, an occupant detection unit 420, the vibration amount calculation unit 430, an output determination unit 460, an occupant identification information acquirement unit 470, a movement detection unit 480, and a storage control unit 490. The occupant detection device 400 also includes a not-illustrated control unit.

The analysis unit 410, the occupant detection unit 420, the vibration amount calculation unit 430, the output determination unit 460, the occupant identification information acquirement unit 470, the movement detection unit 480, and the storage control unit 490 may be distributed among servers on a network. In this case, the not-illustrated control unit communicates with each of the components, to cause the component to perform its process.

The analysis unit 410 calculates the distance to the detection target 1001, a speed and an angle with respect to the detection target 1001, etc. on the basis of the signals of the transmission wave Tx and the received wave Rx from the electric wave sensor 100, and outputs them to the occupant detection unit 420. As a more concrete calculation method, a known technique, such as a pulse method or a frequency modelated continuous wave (FMCW) method, should just be used. Therefore, a detailed explanation of the calculation method is omitted here.

The occupant detection unit 420 outputs the occupant detection results about occupants, each of the occupant detection results being detected using an electric wave, each of the occupant detection results being about a corresponding one of seats.

In the present disclosure, the occupant detection unit 420 is also referred to as a first occupant detection unit.

Further, in the present disclosure, the occupant detection results provided by the first occupant detection unit are also referred to as first detection results.

Concretely, the occupant detection unit 420 acquires analysis results which are based on the signals from the electric wave sensor 100 from the analysis unit 410, and performs detection about an occupant. The occupant detection results include, for example, multiple types of detection results including the presence or absence of an occupant of each seat, the physique of the occupant, the posture of the occupant, and biological information about the occupant. Each of the occupant detection results includes, in addition to information indicating the detection result itself, seat information, information for identifying the type of the occupant detection result, and a degree of reliability corresponding to the occupant detection result. The seat information is position information indicating a seat position.

As to each of the above-mentioned pieces of information outputted by the occupant detection unit 420, a detailed name of the information included in the occupant detection result may be omitted and the information may be simply described as an occupant detection result in the following explanation.

In addition, concretely, the occupant detection unit 420 includes at least one of an occupant presence or absence determination unit 421, a physique determination unit 422, a posture determination unit 423, and a biological information detection unit 424.

The occupant presence or absence determination unit 421 expresses a movable body (occupant) with three-dimensional (horizontal, vertical, and depth directions) information on the basis of the information about the distance to the detection target 1001 and the information about the speed with respect to the detection target 1001, which are acquired from the analysis unit 410, and determines the presence or absence of the occupant from the three-dimensional information. The occupant presence or absence determination unit 421 outputs, as an occupant detection result, information for identifying a seat position, occupant presence or absence information indicating the presence or absence of the occupant, and the degree of reliability of the detection result. The occupant presence or absence information is, for example, binary information indicating presence or absence.

As a method of determining the presence or absence of an occupant, there is, for example, a method of preparing a statistical model for occupant presence or absence in advance, and calculating a determination result and the degree of reliability of the determination result from the degree of similarity between detected three-dimensional information and the statistical model. Further, a rule for judging the result may be determined and a moving average of output values within a certain time period may be calculated, thereby providing a degree of reliability.

The physique determination unit 422 expresses a movable body (occupant) with three-dimensional (horizontal, vertical, and depth directions) information on the basis of the information about the distance to the detection target 1001 and the information about the speed with respect to the detection target 1001, which are acquired from the analysis unit 410, and determines the physique of the occupant from the three-dimensional information. The physique determination unit 422 outputs, as an occupant detection result, information for identifying a seat position, physique information indicating the physique of the occupant, and the degree of reliability of the occupant detection result. The physique information is, for example, information indicating a result of classifying the physique of the occupant as one of adult, child and so on.

As a method of determining the physique of an occupant, there is, for example, a method of preparing statistical models for physiques (adult, child, and so on) in advance, and calculating a determination result and the degree of reliability of the determination result from the degrees of similarity between detected three-dimensional information and the statistical models. Further, a rule for judging the result may be determined and a moving average of output values within a certain time period may be calculated, thereby providing a degree of reliability.

The posture determination unit 423 expresses a movable body (occupant) with three-dimensional (horizontal, vertical, and depth directions) information on the basis of the information about the distance to the detection target 1001 and the information about the speed with respect to the detection target 1001, which are acquired from the analysis unit 410, and determines the posture of the occupant from the three-dimensional information. The posture determination unit 423 outputs, as an occupant detection result, information for identifying a seat position, posture information indicating the posture of the occupant, and the degree of reliability of the occupant detection result. The posture information is, for example, information indicating a result of classifying the posture as one of predetermined occupant posture patterns, such as normality, falling sideways, and facedown.

As a method of determining the posture of an occupant, there is, for example, a method of preparing statistical models for postures (normality, facedown, and so on) in advance, and calculating a determination result and the degree of reliability of the determination result from the degrees of similarity between detected three-dimensional information and the statistical models. Further, a rule for judging the result may be determined and a moving average of output values within a certain time period may be calculated, thereby providing a degree of reliability.

The biological information detection unit 424 performs signal processing on a reflection signal containing a variation in an occupant's body surface, for example, thereby separating and extracting a waveform of breathing and a waveform of heart beats, and calculating a breathing rate and a heart rate from the waveforms after the separation. This means that the appearance of a fine body surface variation in the reflection signal acquired from the analysis unit 410 and reflected from the detection target 1001, the variation being caused by the occupant's breathing and heart beats, is used.

A known technique should just be used as the signal processing for extracting breathing and heartbeats, and thus a detailed explanation of the technique will be omitted hereinafter.

For example, when a breathing rate and a heart rate are calculated at certain intervals (e.g., at intervals of one second), a moving average of results of success or failure (e.g., 0 or 1) of detection of breathing and heart beats is calculated within a predetermined time period (e.g., a time period of one minute), and the result of the calculation of the moving average is defined as the degree of reliability corresponding to the breathing rate and the heart rate.

The biological information detection unit 424 outputs, as an occupant detection result, information for identifying a seat position, biological information, and the degree of reliability of the occupant detection result. The biological information is, for example, information indicating a breathing rate per minute and a heart rate per minute, or the like.

The biological information detection unit 424 may use the vibration amount of the vehicle acquired from the acceleration sensor or the like, and thereby may be able to distinguish between breathing/heart beats and vibrations at the time of the calculation of the breathing rate and the heart rate.

Each of the calculation methods in the occupant presence or absence determination unit 421, the physique determination unit 422, the posture determination unit 423, and the biological information detection unit 424 which are included in the occupant detection unit 420 may use one of various well-known techniques including a machine learning method of, for example, learning a relation between a pre-defined feature quantity effective for classification and a desired result in advance on the basis of information acquired from the analysis unit 410, and classifying information acquired from the analysis unit 410 according to the learning model.

The occupant detection unit 420 may perform the detection again at predetermined certain intervals or in accordance with situations. The situations include, for example, at least one of a time when the vehicle stops, a time when the vehicle speed becomes less than or equal to a predetermined speed, a time when the vibration amount of the vehicle becomes less than or equal to a predetermined amount, a time when a vehicle door is closed, and a time when a change occurs in the position of an occupant in the vehicle.

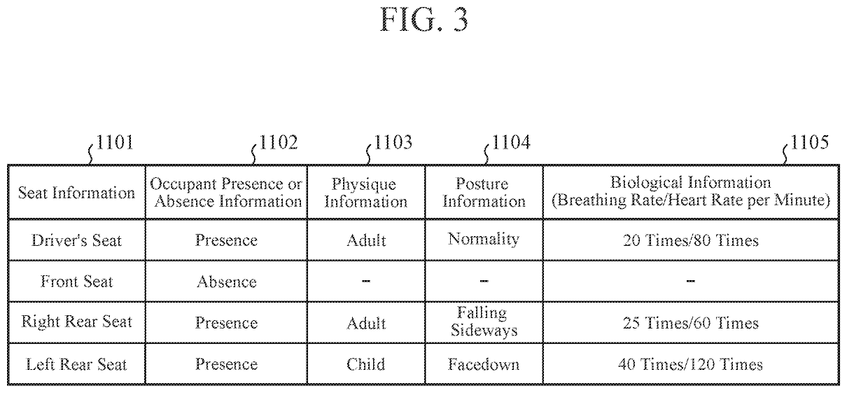

FIG. 3 is a table explaining an example of the pieces of information contained in the occupant detection results in the occupant detection unit 420 of the occupant detection device 400.

The seat information 1101 for identifying a seat position is, for example, information such as the driver's seat, a front seat, a right rear seat, or a left rear seat.

The occupant presence or absence information 1102 is, for example, information indicating the presence or absence of an occupant.

The physique information 1103 is, for example, information such as an adult or a child.

The posture information 1104 is, for example, information such as normality, falling sideways, or facedown.

The biological information 1105 is, for example, a breathing rate and a heart rate per minute, and is information such as 20 times/80 times, 25 times/60 times, or 40 times/120 times.

Further, a degree of reliability is added to each of the following pieces of information: the occupant presence or absence information 1102, the physique information 1103, the posture information 1104, and the biological information 1105. The description of the degree of reliability is omitted in FIG. 3.

Although in the above-mentioned explanation, the occupant detection results containing the degrees of reliability are explained, the degrees of reliability do not have to be contained because the degrees of reliability are not used in Embodiment 1. An occupant detection device using the degrees of reliability will be explained in Embodiment 2.

The vibration amount calculation unit 430 shown in FIG. 1 analyzes the amplitude, the number of vibrations, etc. in the rotation angular speed in each of the three axes: the pitch axis, the roll axis, and the yaw axis, which is acquired from the vibration detection sensor 200, and thereby calculates the vibration amount in each of the axes. As an alternative, the vibration amount calculation unit 430 may calculate the vibration amount using information such as the acceleration, the vehicle speed, the accelerator quantity, the steering angle, the blinker lighting state, or the brake amount. One of various well-known techniques can be used for the calculation of the vibration amount, and a detailed explanation of these techniques will be omitted hereinafter.

In a case where the vehicle speed of the vehicle is used for the vibration detection sensor 200, the vehicle speed itself may be handled as the vibration amount, for example. More specifically, although in Embodiment 1 the configuration of including the vibration amount calculation unit 430 is explained, the occupant detection device 400 of the present disclosure may use information indirectly indicating the vibration amount, and thus does not necessarily include the vibration amount calculation unit 430.

The output determination unit 460 determines whether to adopt or reject the occupant detection results (first detection results) in accordance with the vibration amount, and, when determining to adopt the occupant detection results, outputs the occupant detection results.

A method of determining whether to adopt or reject occupant detection results is not limited to a specific method. For example, a method of determining not to adopt occupant detection results when the vibration amount exceeds a predetermined threshold may be used.

The output determination unit 460 may be configured in such a way as to receive either a notification that an occupant is moving or a notification indicating a start of a movement of an occupant and a notification indicating an end of the movement of the occupant, from the movement detection unit 480. In this case, when receiving the notification, the output determination unit 460 determines that the occupant is moving from the notification, and does not output any occupant detection result during the movement of the occupant.

On the basis of the signal from the vehicle-mounted sensor 300, the occupant identification information acquirement unit 470 acquires information from which the position of an occupant and features which enable identification of the occupant can be detected. Then, the occupant identification information acquirement unit 470 generates seat information indicating the seat position of the occupant and occupant identification information for identifying the occupant. As to each of the above-mentioned pieces of information generated by the occupant identification information acquirement unit 470, the occupant identification information to which the seat information is added may be simply described as the occupant identification information in the following explanation.

Concretely, the occupant identification information acquirement unit 470 identifies a sitting occupant for each seat on the basis of the information acquired from the vehicle-mounted sensor, and outputs the occupant identification information corresponding to the seat to the movement detection unit 480.

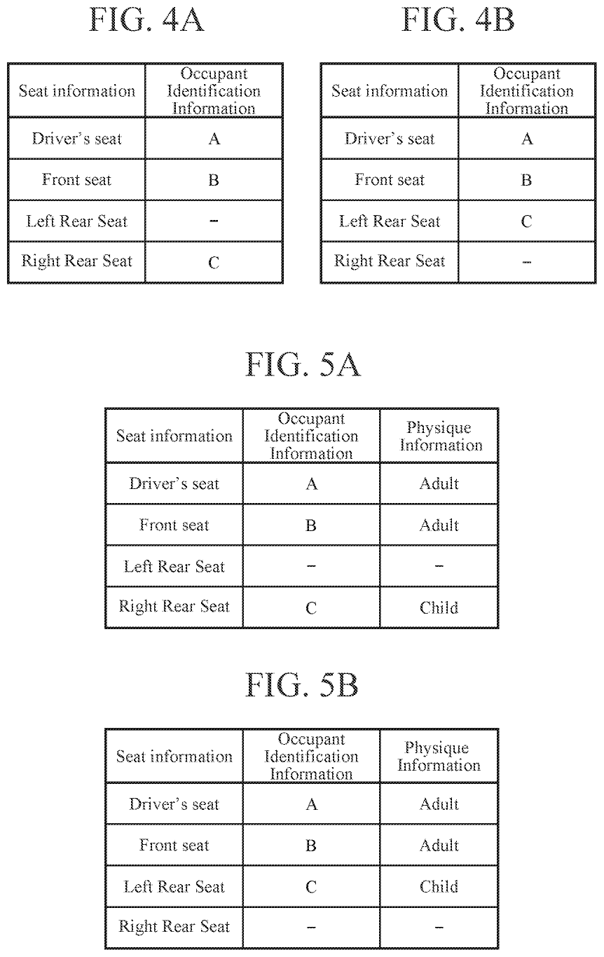

FIGS. 4A and 4B are tables each showing an example of the pieces of seat information and the pieces of occupant identification information in the occupant detection device 400.

As shown in FIG. 4A or 4B, the pieces of occupant identification information are, for example, unique IDs or the likes which are assigned to occupants sitting in seats. These IDs should just be determined in such a way as to be incrementally named as A, B, C, . . . in the order in which the occupants have been detected.

As an example of a method of identifying an occupant, there is a method capable of, within a predetermined time period at the time when an occupant is getting in the vehicle, creating a learning model on the basis of feature quantities for identifying the occupant, and identifying the occupant from the degree of similarity between feature quantities newly acquired and the learning model. A concrete example of the feature quantities includes feature quantities related to an occupant's face and body in the case of using a camera, feature quantities related to a sound in the case of using a microphone, or feature quantities related to a weight in the case of using a seating pressure sensor.

The movement detection unit 480 detects a movement as to each of occupants detected using means other than an electric wave, and outputs the position of each of the occupants.

Concretely, the movement detection unit 480 detects a movement of a sitting occupant for each seat on the basis of the information acquired from the vehicle-mounted sensor 300, and outputs the pieces of occupant identification information acquired from the occupant identification information acquirement unit 470 to the storage control unit 490 on the basis of a result of the detection. For example, when an occupant C in the right rear seat moves to the left rear seat in the case of FIG. 4A, the occupant identification information about the left rear seat is corrected to C, as shown in FIG. 4B, and this occupant identification information is outputted to the storage control unit 490. When no occupant movement is detected, the pieces of occupant identification information corresponding to respective seats from the occupant identification information acquirement unit 470 are outputted to the storage control unit 490, just as they are.

In the case of using a camera, for example, as the vehicle-mounted sensor, an existing technique of tracking the head of an occupant using a particle filter method or the like should just be used as the method of detecting a movement of an occupant, and a detailed explanation of the technique will be omitted hereinafter. In the case of using an array microphone as the vehicle-mounted sensor, the utterance of an occupant may be collected using the array microphone, and the time difference of the sound appearing between microphones may be calculated using a method such as a cross-correlation method, to calculate the direction of arrival of the occupant's sound, thereby detecting that the occupant has moved. In the case of using a seating pressure sensor, a movement of an occupant from one seat to another should just be detected from a change in the weight at each seat surface.

The storage control unit 490 stores each of occupant detection results adopted by the output determination unit 460 and corresponding occupant identification information outputted from the movement detection unit 480 in a not-illustrated storage unit while linking them together using the seat information common to them.

When the movement detection unit 480 detects a movement of an occupant in a state where no occupant detection result is outputted from the output determination unit 460, the storage control unit 490 corrects, using the occupant identification information, the links between the occupant detection results and the pieces of seat information stored in the storage unit, and then outputs the detection results and the pieces of seat information after the correction.

Concretely, at predetermined certain time intervals, the storage control unit 490 determines whether or not to have acquired an occupant detection result from the output determination unit 460. When determining to have acquired an occupant detection result, the storage control unit 490 stores the occupant detection result in the storage unit. When determining not to have acquired an occupant detection result, the storage control unit 490 acquires the occupant identification information from the movement detection unit 480, and causes the storage unit to store an occupant detection result stored in the storage unit and the occupant identification information while linking the occupant detection result and the occupant identification information together using seat information.

FIGS. 5A and 5B are tables explaining an example of the correction of pieces of occupant detection information by the occupant detection device 400.

First, an example of storage in the storage unit will be explained. For example, as shown in FIG. 5A, the occupant detection result (physique determination result in this example) adopted by the output determination unit 460 and occupant identification information are stored while the occupant detection result and the occupant identification information are linked together for each seat.

Further, when receiving an update of occupant identification information from the movement detection unit 480, the storage control unit 490 also updates the occupant detection result which is stored while being linked with the occupant identification information. For example, when the movement detection unit 480 detects that an occupant C has moved from the right rear seat to the left rear seat, as shown in FIG. 5B, the result of the physique determination on the left rear seat is updated to “child” because it is known that the physique of the occupant C is child, as shown in FIG. 5A.

The hardware configuration of the occupant detection system 1 will be explained.

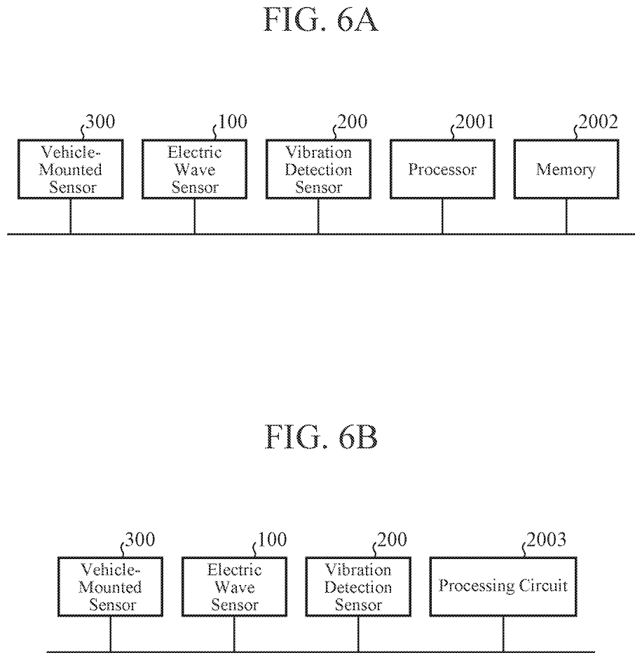

Each of FIGS. 6A and 6B is a diagram showing an example of the hardware configuration of the occupant detection system 1 including the occupant detection device 400.

As shown in FIG. 6A, the occupant detection system 1 is constituted by the electric wave sensor 100, the vibration detection sensor 200, a processor 2001, and a memory 2002. The processor 2001 and the memory 2002 are mounted in, for example, a computer.

Programs for causing the computer to function as the analysis unit 410, the occupant detection unit 420, the vibration amount calculation unit 430, the output determination unit 460, the occupant identification information acquirement unit 470, the movement detection unit 480, the storage control unit 490, and the not-illustrated control unit are stored in the memory 2002. The functions of the analysis unit 410, the occupant detection unit 420, the vibration amount calculation unit 430, the output determination unit 460, the occupant identification information acquirement unit 470, the movement detection unit 480, the storage control unit 490, and the not-illustrated control unit are implemented by the processor 2001's reading and executing the programs stored in the memory 2002.

As the processor 2001, for example, a central processing unit (CPU), a graphics processing unit (GPU), a microprocessor, a microcontroller, or a digital signal processor (DSP) is used.

The memory 2002 may be a non-volatile or volatile semiconductor memory such as a random access memory (RAM), a read only memory (ROM), an erasable programmable ROM (EPROM), or a flash memory, a magnetic disc such as a hard disc or a flexible disc, an optical disc such as a compact disc (CD) or a digital versatile disc (DVD), or a magneto-optical disc.

As an alternative, the functions of the analysis unit 410, the occupant detection unit 420, the vibration amount calculation unit 430, the output determination unit 460, the occupant identification information acquirement unit 470, the movement detection unit 480, the storage control unit 490, and the not-illustrated control unit may be implemented by a processing circuit 2003 for exclusive use, as shown in FIG. 6B. As the processing circuit 2003, for example, a single circuit, a composite circuit, a programmable processor, a parallel programmable processor, an application specific integrated circuit (ASIC), a programmable logic device (PLD), a field-programmable gate array (FPGA), a system-on-a-chip (SoC), or a system large-scale integration (LSI) is used.

As an alternative, a part of the functions of the analysis unit 410, the occupant detection unit 420, the vibration amount calculation unit 430, the output determination unit 460, the occupant identification information acquirement unit 470, the movement detection unit 480, the storage control unit 490, and the not-illustrated control unit may be implemented by the processor 2001 and the memory 2002, and the remaining functions may be implemented by the processing circuit 2003.

A part of the functions of the analysis unit 410, the occupant detection unit 420, the vibration amount calculation unit 430, the output determination unit 460, the occupant identification information acquirement unit 470, the movement detection unit 480, the storage control unit 490, and the not-illustrated control unit may be implemented by hardware for exclusive use, and another part of the functions may be implemented by software or firmware. As mentioned above, the processing circuit 2003 in the occupant detection system 1 can implement the above-mentioned functions by using hardware, software, firmware, or a combination of hardware, software and firmware.

Next, an example of the processing performed in the occupant detection device 400 will be explained.

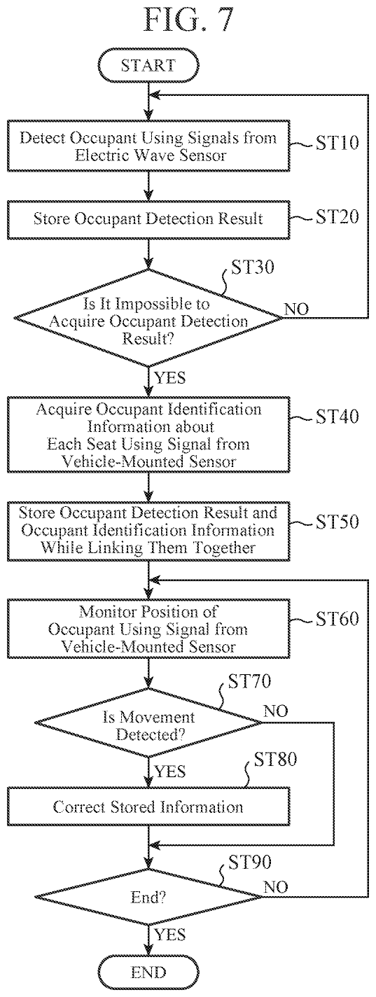

FIG. 7 is a flowchart showing the processing performed in the occupant detection device 400.

The occupant detection device 400 starts the processing at the time when the engine of the vehicle is started, for example.

In the occupant detection device 400, the analysis unit 410 and the occupant detection unit 420 perform occupant detection using the signals outputted from the electric wave sensor. When determining to output occupant detection results, the output determination unit 460 of the occupant detection device 400 outputs the occupant detection results (pieces of information indicating the detection results and pieces of seat information), each of the occupant detection results being about a corresponding one of seats (step ST10).

When receiving the occupant detection results, the storage control unit 490 performs control to cause the storage unit to store the occupant detection results for the respective pieces of seat information. The storage unit stores the occupant detection results (the pieces of information indicating the detection results and the pieces of seat information) (step ST20).

The storage control unit 490 determines whether or not it is impossible to acquire an occupant detection result (step ST30). When the storage control unit 490 determines that it is not impossible to acquire an occupant detection result (when “NO” in step ST30), the occupant detection device 400 repeats the processes from step ST10.

When determining that it is impossible to acquire an occupant detection result (when “YES” in step ST30), the storage control unit 490 acquires pieces of occupant identification information about respective seats (pieces of occupant identification information and pieces of seat information), which are acquired using the signal outputted from the vehicle-mounted sensor, via the occupant identification information acquirement unit 470 and the movement detection unit 480 (step ST40).

The storage control unit 490 causes the not-illustrated storage unit to store each of the occupant detection results and corresponding occupant identification information while linking them together using the seat information common to them (step ST50).

The movement detection unit 480 monitors the position of each occupant using pieces of seat information and pieces of occupant identification information which are acquired from the output signal of the vehicle-mounted sensor 300 via the occupant identification information acquirement unit 470 (step ST60).

The movement detection unit 480 determines whether it is detected that an occupant has moved (step ST70).

When detecting that an occupant has moved (when “YES” in step ST70), the movement detection unit 480 outputs the seat information and the occupant identification information about the detected occupant to the storage control unit 490.

The storage control unit 490 acquires the seat information and the occupant identification information which are outputted from the movement detection unit 480, and corrects the pieces of information stored in the not-illustrated storage unit using the seat information and the occupant identification information (step ST80).

The not-illustrated control unit determines whether to end the processing performed in the occupant detection device 400 (step ST90).

When the not-illustrated control unit determines not to end the processing (when “NO” in step ST90), the processes from step ST10 are repeated.

When the not-illustrated control unit determines to end the processing (when “YES” in step ST90), the occupant detection device 400 ends the processing.

The occupant detection device 400 according to Embodiment 1 can cause the outputted occupant detection results to be stored in advance, and then correct and output the stored occupant detection results in accordance with a movement of an occupant, by using the seats and positions of the occupants detected by means other than an electric wave. As a result, even when an occupant moves from one seat to another in a state where vibrations occur in the vehicle, the occupant detection device 400 can output occupant detection results with few errors caused by the vibrations.

As mentioned above, the occupant detection device according to the present disclosure detects one or more occupants riding in a vehicle, and includes: the occupant detection unit to output one or more detection results about the respective one or more occupants, each of the one or more detection results being detected using an electric wave, each of the one or more detection results being about a corresponding one of seat positions of the one or more occupants; the output determination unit to determine whether to adopt or reject the one or more detection results provided by the occupant detection unit in accordance with the vibration amount of the vehicle, and to, when the one or more detection results are adopted, output the one or more detection results; the storage control unit to cause the storage unit to store the one or more detection results outputted by the output determination unit while linking the one or more detection results with the respective seat positions in the vehicle, and to then output the one or more detection results; and the movement detection unit to detect a movement as to each of the one or more occupants detected using means other than an electric wave, and to output pieces of position information about the respective one or more occupants. When the movement detection unit detects a movement of one of the one or more occupants in a state where no detection result is outputted from the output determination unit, the storage control unit corrects, using a corresponding one of the pieces of position information about the respective one or more occupants, a link between a corresponding one of the one or more detection results and a corresponding one of the seat positions which are stored in the storage unit, and then outputs corrected information indicating both the one or more detection results and the seat positions.

As a result, there is provided an advantage of being able to provide an occupant detection device that outputs an occupant detection result with few errors even when an occupant moves from one seat to another in a state where vibrations occur in the vehicle.

The occupant detection device according to the present disclosure is further configured in such a way that, when the vibration amount of the vehicle is greater than or equal to the threshold, the output determination unit does not output any detection result provided by the occupant detection unit.

As a result, there is provided a further advantage of being able to provide an occupant detection device that outputs an occupant detection result with few errors even when an occupant moves from one seat to another in a state where vibrations occur in the vehicle.

The occupant detection device according to the present disclosure is further configured in such a way that each detection result provided by the occupant detection unit includes at least one of the presence or absence of an occupant, the physique of the occupant, the posture of the occupant, and biological information.

As a result, there is provided a further advantage of being able to provide an occupant detection device that outputs the presence or absence of an occupant, the physique of an occupant, the posture of an occupant, and biological information which have few errors even when an occupant moves from one seat to another in a state where vibrations occur in the vehicle.

The occupant detection device according to the present disclosure is further configured in such a way that while the movement detection unit detects a movement of an occupant, the output determination unit does not output any detection result provided by the occupant detection unit.

As a result, there is provided a further advantage of being able to provide an occupant detection device that outputs an occupant detection result with few errors even when an occupant moves from one seat to another in a state where vibrations occur in the vehicle.

The occupant detection device according to the present disclosure further includes the occupant identification information acquirement unit to generate occupant identification information indicating both an occupant detected using means other than an electric wave, and a seat position detected using the means other than an electric wave. The storage control unit causes the storage unit to store the detection result outputted by the output determination unit while linking the detection result with the occupant identification information. When the movement detection unit detects that a movement of an occupant is completed, the storage control unit corrects, using occupant identification information after the movement of the occupant is completed, a link between the detection result and the occupant identification information which are stored in the storage unit.

As a result, there is provided a further advantage of being able to provide an occupant detection device that outputs an occupant detection result with few errors even when an occupant moves from one seat to another in a state where vibrations occur in the vehicle.

The occupant detection device according to the present disclosure is further configured in such a way that the position information about each occupant results from detecting the occupant and the seat position using at least one of an image capture device, a sound collection device, and a seating pressure sensor.

As a result, there is provided a further advantage of being able to provide an occupant detection device that outputs an occupant detection result with few errors using a signal from an image capture device, a sound collection device, or a seating pressure sensor as a sensor other than an electric wave.

The occupant detection method according to the present disclosure is one of detecting one or more occupants riding in a vehicle, and includes the steps of: by the occupant detection unit, outputting one or more detection results about the respective one or more occupants, each of the one or more detection results being detected using an electric wave, each of the one or more detection results being about a corresponding one of seat positions of the one or more occupants; by the output determination unit, determining whether to adopt or reject the one or more detection results provided by the occupant detection unit in accordance with the vibration amount of the vehicle, and, when the one or more detection results are adopted, outputting the one or more detection results; by the storage control unit, causing the storage unit to store the one or more detection results outputted by the output determination unit while linking the one or more detection results with the respective seat positions in the vehicle, and then outputting the one or more detection results; by the movement detection unit, detecting a movement as to each of the one or more occupants detected using means other than an electric wave, and outputting pieces of position information about the respective one or more occupants; and when the movement detection unit detects a movement of one of the one or more occupants in a state where no detection result is outputted from the output determination unit, by the storage control unit, correcting, using a corresponding one of the pieces of position information about the respective one or more occupants, a link between a corresponding one of the one or more detection results and a corresponding one of the seat positions which are stored in the storage unit, and then outputting corrected information indicating both the one or more detection results and the seat positions.

As a result, there is provided an advantage of being able to provide an occupant detection device that outputs an occupant detection result with few errors even when an occupant moves from one seat to another in a state where vibrations occur in the vehicle.

### Embodiment 2

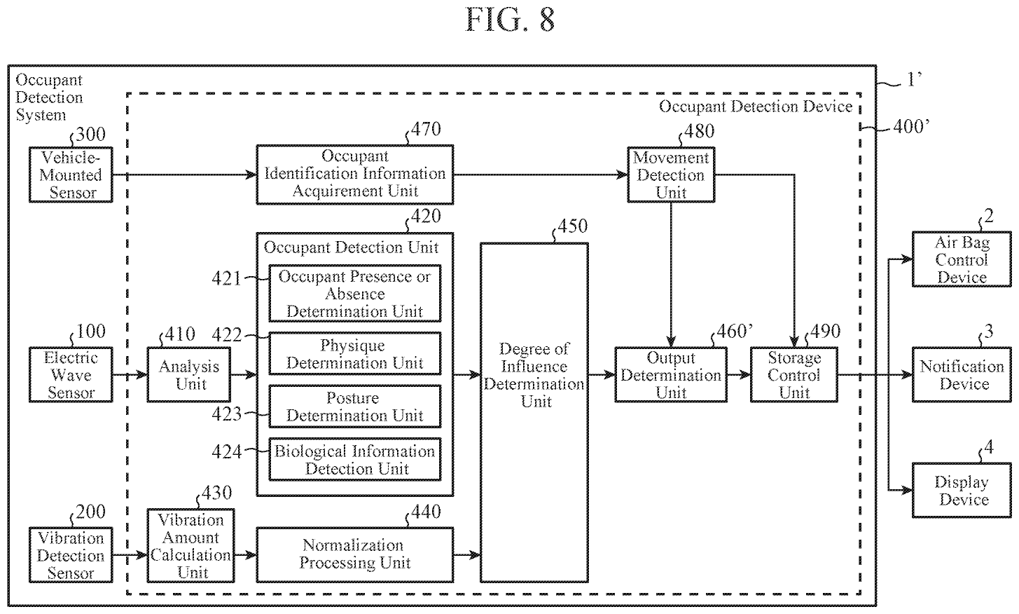

An occupant detection device according to Embodiment 2 and an occupant detection system including this occupant detection device will be explained using FIGS. 8 to 12.

Embodiment 2 is an embodiment of, in a state where vibrations occur, outputting occupant detection results with a small influence of the vibrations while taking into consideration the degree of influence which depends on the vibration amount as to each of the types of the occupant detection results, in addition to Embodiment 1.

FIG. 8 is a diagram showing the configuration of the occupant detection system 1′ according to Embodiment 2.

The occupant detection system 1′ shown in FIG. 8 differs from the occupant detection system 1 shown in FIG. 1 in that a normalization processing unit 440 and a degree of influence determination unit 450 are added. Further, the occupant detection system 1′ shown in FIG. 8 differs in an output determination unit 460′ from the occupant detection system 1 shown in FIG. 1.

Hereinafter, an explanation will be made, using FIG. 8, particularly as to the components different from those in FIG. 1, and an explanation as to the same components as those in FIG. 1 will be omitted as appropriate.

The normalization processing unit 440 normalizes the vibration amount acquired from a vibration amount calculation unit 430. As a normalizing method, for example, a method of setting the vibration amount to “1” when vibrations do not occur at all, and normalizing the vibration amount in such a way as to cause the vibration amount to approach “0” as vibrations become large should just be used. The normalization processing unit 440 outputs the vibration amount normalized thereby (referred to as the “normalized vibration amount” hereinafter) to the degree of influence determination unit 450.

Although in Embodiment 1 the normalized vibration amount which is acquired by normalizing the vibration amount is used, the occupant detection device 400′ of the present disclosure should just be able to determine, as to each of the types of the occupant detection results, whether or not to output the occupant detection result in consideration of the influence which depends on the vibration amount, and does not necessarily include the normalization processing unit 440.

The degree of influence determination unit 450 acquires the normalized vibration amount from the normalization processing unit 440, and uses this normalized vibration amount and the occupant detection results (first detection results) from an occupant detection unit 420, to determine the degree of influence of vibrations as to each of the types of the occupant detection results.

For example, concretely, from a degree of influence on vibrations (referred to as the “degree of vibration influence” hereinafter, where the degree of vibration influence is defined in advance as to each of the types of the occupant detection results), the degree of influence corresponding to an occupant detection result type, and the normalized vibration amount acquired from the normalization processing unit 440, the degree of influence determination unit 450 calculates a vibration amount (referred to as a “corrected vibration amount” hereinafter) which is acquired by correcting the normalized vibration amount with the value of the degree of vibration influence.

Although the “corrected vibration amount” is used in the explanation, a term “degree of influence” can be simply used in the present disclosure instead of the term “corrected vibration amount” because the “corrected vibration amount” is a value which is acquired by correcting the normalized vibration amount with the value of the degree of vibration influence. More specifically, the degree of influence determination unit 450 calculates, as to each of the types of the occupant detection results (first detection results), the “corrected vibration amount” as the degree of influence which depends on the vibration amount.

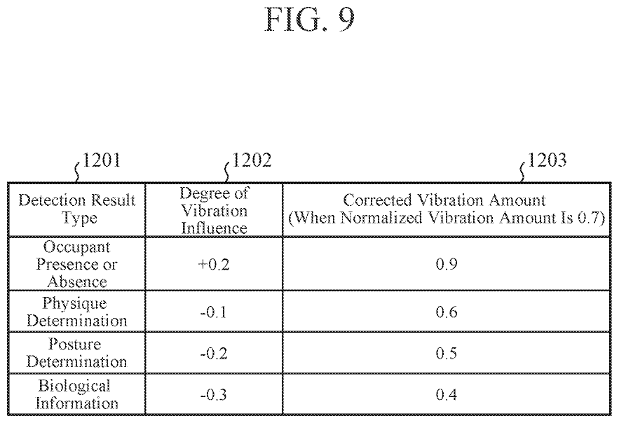

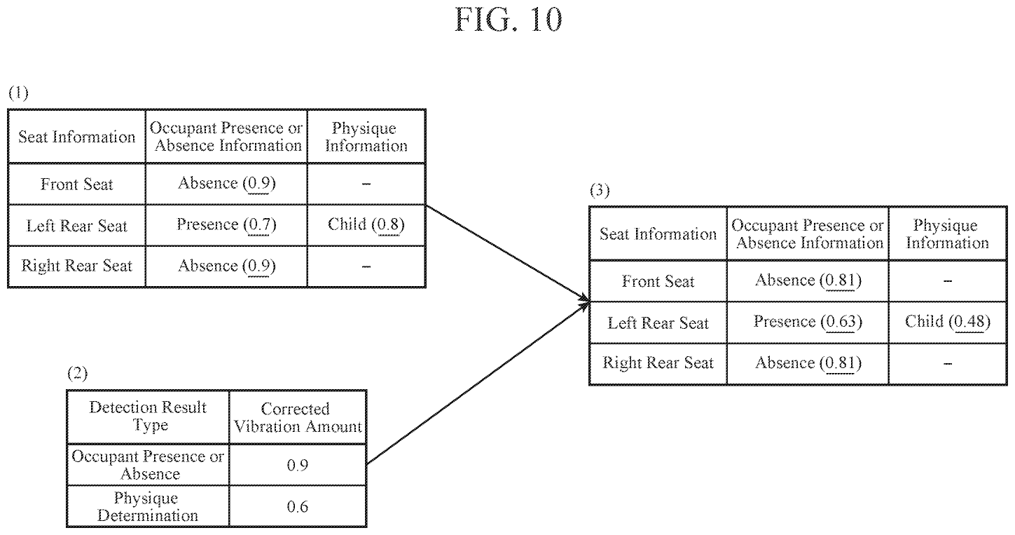

FIG. 9 is a table explaining an example of the degree of vibration influence for each of the types of the occupant detection results, and the corrected vibration amount after correction which is corrected using the degree of the influence.

For example, as shown in FIG. 9, the degree of vibration influence 1202 is determined in advance as to each of the types 1201 of the occupant detection results, and the degree of influence determination unit 450 calculates the corrected vibration amount 1203 as to each of the types of the occupant detection results.

The corrected vibration amounts 1203 corresponding to the respective detection types 1201 when the normalized vibration amount is “0.7” are shown in FIG. 9. When the type 1201 of a detection result is “occupant presence or absence”, the degree of influence determination unit 450 adds the degree of vibration influence 1202 of “+0.2” to the normalized vibration amount of “0.7”, thereby calculating the corrected vibration amount 1203 of “0.9.” When the type of a detection result is “physique determination”, the degree of influence determination unit 450 adds the degree of vibration influence 1202 of “−0.1” to the normalized vibration amount of “0.7”, thereby calculating the corrected vibration amount 1203 of “0.6.” When the type 1201 of a detection result is “posture determination”, the degree of influence determination unit 450 adds the degree of vibration influence 1202 of “−0.2” to the normalized vibration amount of “0.7”, thereby calculating the corrected vibration amount 1203 of “0.5”. When the type 1201 of a detection result is “biological information”, the degree of influence determination unit 450 adds the degree of vibration influence 1202 of “−0.3” to the normalized vibration amount of “0.7”, thereby calculating the corrected vibration amount 1203 of “0.4”. The “degrees of vibration influence” in FIG. 9 are determined in such a way that their values increase in the negative direction as the influence of vibrations on the detection results becomes stronger, while their values increase in the positive direction as the influence of vibrations on the detection results becomes weaker.

In this example, although the corrected vibration amounts 1203 do not exceed the maximum “1” of the normalized vibration amount, the corrected vibration amount 1203 in the detection result type 1201 of “occupant presence or absence” is “1.1” and thus exceeds the maximum “1” of the normalized vibration amount if the normalized vibration amount is “0.9.” In such a case, the degree of influence determination unit 450 performs a process of correcting the corrected vibration amount 1203 of “1.1” to “1.0.”

Although the degree of influence determination unit 450 determines the degree of vibration influence 1202 for each of the types of the occupant detection results in advance, the degree of influence determination unit 450 may determine the degree of vibration influence while also taking into consideration the degree of influence which depends on each seat.

The output determination unit 460′ uses the corrected vibration amount (the degree of influence which depends on the vibration amount) which is acquired from both the degree of vibration influence for each of the types of the occupant detection results, and the normalized vibration amount, to determine whether to adopt or reject the occupant detection result (first detection result), and, when determining to adopt the occupant detection result, causes the occupant detection result to be outputted.

For example, the output determination unit 460′ determines the necessity or unnecessity of adopting the detection result on the basis of the occupant detection result acquired from the occupant detection unit 420 via the degree of influence determination unit 450 (the information indicating the detection result, the information for identifying the type of the detection result, and the degree of reliability corresponding to the type of the detection result), the corrected vibration amount acquired from the degree of influence determination unit 450, and a threshold for determining whether or not to adopt the detection result (referred to as the “threshold” hereinafter).

A determination method in the output determination unit 460′ includes “a first method of correcting the degree of reliability using the corrected vibration amount, and comparing the degree of reliability after correction (referred to as the “corrected degree of reliability” hereinafter) with the threshold, to determine whether to adopt or reject the occupant detection result”, “a second method of correcting the threshold using the corrected vibration amount, and comparing the degree of reliability with the corrected threshold, to determine whether to adopt or reject the occupant detection result”, and “a third method of correcting the degree of reliability and the threshold using the corrected vibration amount, and comparing the corrected degree of reliability with the corrected threshold, to determine whether to adopt or reject the occupant detection result”. Any one of these methods may be used.

For example, concretely, the first method is a “method of changing the degree of reliability corresponding to the type of the occupant detection result in accordance with the corrected vibration amount, and, when the changed degree of reliability (corrected degree of reliability) exceeds the threshold, adopting the occupant detection result.” Further, the second method is a “method of changing the threshold in accordance with the corrected vibration amount, and, when the degree of reliability corresponding to the type of the occupant detection result exceeds the threshold, adopting the occupant detection result.”

Further, the third method is a “method of changing both the degree of reliability corresponding to the type of the occupant detection result, and the threshold in accordance with the corrected vibration amount, and, when the degree of reliability corresponding to the occupant detection result exceeds the threshold, adopting the detection result.”

Hereinafter, a concrete example of the first method will be explained using FIG. 10.

FIG. 10 shows tables explaining an example of correcting the degrees of reliability of occupant detection results using the degrees of vibration influence. In FIG. 10, each of the degrees of reliability is shown in ( ).

Assumptions in the explanation will be explained. It is assumed that “(1) the occupant detection results and the degrees of reliability which are outputted by the occupant detection unit 420” and “(2) the corrected vibration amounts calculated by the degree of influence determination unit 450” inputted to the output determination unit 460′ are as described in FIG. 10, the threshold of the output determination unit 460′ is “0.5”, and the occupant detection unit 420 performs the occupant presence or absence determination and the physique determination. As shown in FIG. 10, for example, the output determination unit 460′ multiplies the degrees of reliability in (1) corresponding to the respective types of the detection results by the corrected vibration amounts in (2) corresponding to the respective types of the detection results, thereby changing the degrees of reliability in (2) as shown in (3). Concretely, because the detection result is child and the degree of reliability is 0.8 in the physique determination on the left rear seat in (1), and the corrected vibration amount of the physique determination in (2) is 0.6, the output determination unit 460′ changes the degree of reliability corresponding to the result of the physique determination on the left rear seat to 0.48 (=0.8×0.6). Because the degree of reliability of 0.48 does not exceed the threshold of “0.5”, the result of the physique determination on the left rear seat is rejected.

A not-illustrated control unit performs a control process of starting or ending the processing performed in the occupant detection device 400′, for example.

The hardware configuration of the occupant detection system 1′ will be explained.

Because the hardware configuration is the same as that of FIGS. 6A and 6B, the hardware configuration will be explained using FIGS. 6A and 6B.

As shown in FIG. 6A, the occupant detection system 1 is constituted by an electric wave sensor 100, a vibration detection sensor 200, a processor 2001, and a memory 2002. The processor 2001 and the memory 2002 are mounted in, for example, a computer.

Programs for causing the computer to function as an analysis unit 410, the occupant detection unit 420, the vibration amount calculation unit 430, the normalization processing unit 440, the degree of influence determination unit 450, the output determination unit 460′, an occupant identification information acquirement unit 470, a movement detection unit 480, a storage control unit 490, and the not-illustrated control unit are stored in the memory 2002. The functions of the analysis unit 410, the occupant detection unit 420, the vibration amount calculation unit 430, the normalization processing unit 440, the degree of influence determination unit 450, the output determination unit 460′, the occupant identification information acquirement unit 470, the movement detection unit 480, the storage control unit 490, and the not-illustrated control unit are implemented by the processor 2001's reading and executing the programs stored in the memory 2002.

As the processor 2001, for example, a central processing unit (CPU), a graphics processing unit (GPU), a microprocessor, a microcontroller, or a digital signal processor (DSP) is used.

The memory 2002 may be a non-volatile or volatile semiconductor memory such as a random access memory (RAM), a read only memory (ROM), an erasable programmable ROM (EPROM), or a flash memory, a magnetic disc such as a hard disc or a flexible disc, an optical disc such as a compact disc (CD) or a digital versatile disc (DVD), or a magneto-optical disc.

As an alternative, as shown in FIG. 6B, the functions of the analysis unit 410, the occupant detection unit 420, the vibration amount calculation unit 430, the normalization processing unit 440, the degree of influence determination unit 450, the output determination unit 460′, the occupant identification information acquirement unit 470, the movement detection unit 480, the storage control unit 490, and the not-illustrated control unit may be implemented by a processing circuit 2003 for exclusive use. As the processing circuit 2003, for example, a single circuit, a composite circuit, a programmable processor, a parallel programmable processor, an application specific integrated circuit (ASIC), a programmable logic device (PLD), a field-programmable gate array (FPGA), a system-on-a-chip (SoC), or a system large-scale integration (LSI) is used.

As an alternative, a part of the functions of the analysis unit 410, the occupant detection unit 420, the vibration amount calculation unit 430, the normalization processing unit 440, the degree of influence determination unit 450, the output determination unit 460′, the occupant identification information acquirement unit 470, the movement detection unit 480, the storage control unit 490, and the not-illustrated control unit may be implemented by the processor 2001 and the memory 2002, and the remaining functions may be implemented by the processing circuit 2003.

A part of the functions of the analysis unit 410, the occupant detection unit 420, the vibration amount calculation unit 430, the normalization processing unit 440, the degree of influence determination unit 450, the output determination unit 460′, the occupant identification information acquirement unit 470, the movement detection unit 480, the storage control unit 490, and the not-illustrated control unit may be implemented by hardware for exclusive use, and another part of the functions may be implemented by software or firmware. As mentioned above, the processing circuit 2003 in the occupant detection system 1 can implement the above-mentioned functions by using hardware, software, firmware, or a combination of hardware, software and firmware.

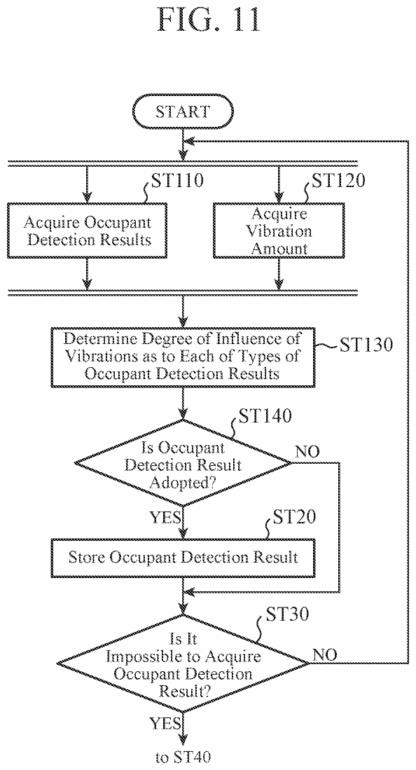

FIG. 11 is a flowchart showing the processing performed in the occupant detection device 400′ according to Embodiment 2.

The flowchart of FIG. 11 relates to the processes in steps ST10 to ST30 of the flowchart of FIG. 7, and the step ST40 and the subsequent steps are the same as the step ST40 and the subsequent steps of the flowchart of FIG. 7.

Therefore, an explanation of the step ST40 and the subsequent steps will be omitted hereinafter.

The occupant detection device 400′ starts the processing at the time when the engine of the vehicle is started, for example.

When receiving a result of analyzing the signals of the electric wave sensor 100 from the analysis unit 410, the occupant detection unit 420 in the occupant detection device 400′ performs detection of multiple types including the presence or absence of an occupant, the physique of the occupant, the posture of the occupant, and biological information about the occupant.

The degree of influence determination unit 450 acquires occupant detection results corresponding to the respective types from the occupant detection unit 420 (step ST10).

The degree of influence determination unit 450 in the occupant detection device 400′ also acquires the vibration amount of the vehicle via the vibration amount calculation unit 430 and the normalization processing unit 440 (step ST20).

When acquiring the occupant detection results and the vibration amount, the degree of influence determination unit 450 uses this vibration amount and the occupant detection results from the occupant detection unit 420, to determine the degree of influence of vibrations as to each of the types of the occupant detection results (step ST30).

After the process of step ST30 is completed, the occupant detection device 400′ proceeds to processes of step ST40 and subsequent steps.

Amore detailed example of the processing performed in the occupant detection device 400′ will be explained using an example of numerical values shown in FIGS. 9 and 10.

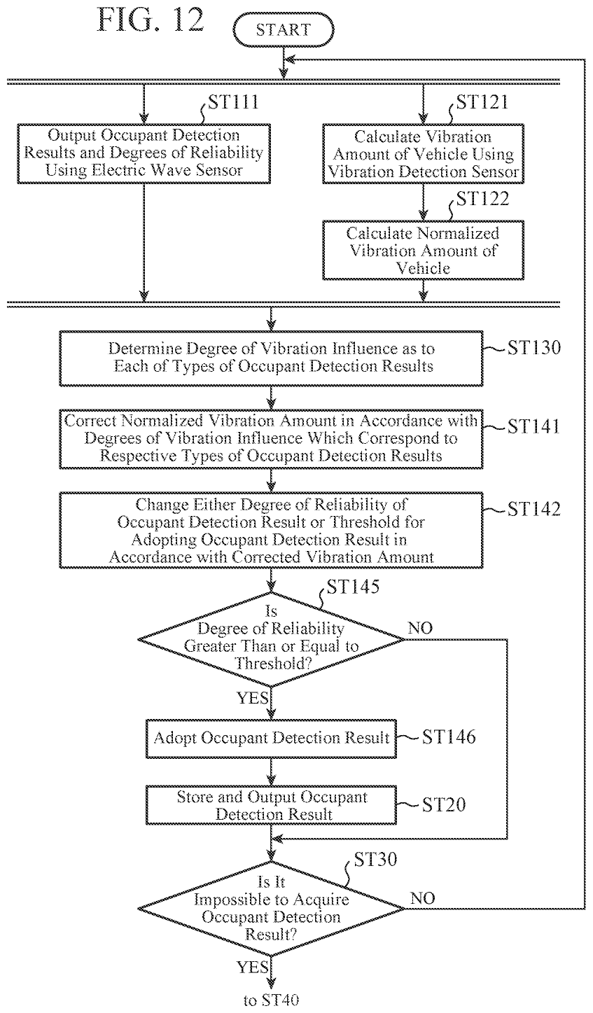

FIG. 12 is a flowchart showing a detailed example of the processing performed in the occupant detection device 400′ according to Embodiment 2.

Hereinafter, an example in which it is assumed that the occupant detection unit 420 outputs the presence or absence of an occupant and the physique of the occupant as occupant detection results, and the physique of the occupant, out of the occupant detection results, is erroneously detected will be explained.

It is assumed that the degrees of vibration influence defined in advance as to the respective types of the occupant detection results are “+0.2 for occupant presence or absence” and “−0.1 for physique determination”, as shown in FIG. 9.

Assuming that the threshold used by the output determination unit 460′ is “0.5”, and the method of determining the necessity or unnecessity of adopting an occupant detection result in the output determination unit 460′ is the first method, the explanation will be made.

The occupant detection unit 420 performs multiple types of occupant detection using the output signals of the electric wave sensor 100, and outputs an occupant detection result about each seat and outputs the degree of reliability as to each of the types of occupant detection results (step ST111). Step ST111 is related to step ST110 in FIG. 11.

Concretely, it is assumed that the occupant detection unit 420 outputs seat information indicating “front seat”, occupant presence or absence information indicating “presence (degree of reliability: 0.7)”, and physique information indicating “child (degree of reliability: 0.8).”

The vibration amount calculation unit 430 calculates the vibration amount of the vehicle using the output signal of the vibration detection sensor 200 (step ST121).

The normalization processing unit 440 normalizes the vibration amount acquired from the vibration amount calculation unit 430, thereby acquiring the normalized vibration amount of “0.7” (step ST122).

Steps ST121 and ST122 are related to step ST120 in FIG. 11.

When acquiring the occupant detection results and the vibration amount, the degree of influence determination unit 450 uses this vibration amount and the occupant detection results from the occupant detection unit 420, to determine the degree of vibration influence as to each of the types of the occupant detection results (step ST130). Concretely, the degree of influence determination unit 450 determines that the degree of vibration influence for the detection result of the occupant presence or absence is “+0.2”, and determines that the degree of vibration influence for the detection result of the physique of the occupant is “−0.1.”

When determining the degrees of vibration influence, the degree of influence determination unit 450 corrects the normalized vibration amount in accordance with the degrees of vibration influence corresponding to the respective types of the occupant detection results (step ST141). Concretely, the degree of influence determination unit 450 adds the degree of vibration influence of “+0.2” for the detection result of the occupant presence or absence to the normalized vibration amount of “0.7”, thereby calculating the corrected vibration amount of “0.9.” The degree of influence determination unit 450 also adds the degree of vibration influence of “−0.1” for the detection result of the physique of the occupant to the normalized vibration amount of “0.7”, thereby calculating the corrected vibration amount of “0.6.”

The output determination unit 460′ changes either the degree of reliability of each occupant detection result or the threshold for determining whether to adopt or reject the detection result, in accordance with the vibration amount after the correction (corrected vibration amount) (step ST142). Concretely, in the case of changing the degree of reliability of each occupant detection result, the output determination unit 460′ multiplies the degree of reliability of “0.7” of the detection result of the occupant presence or absence and the corrected vibration amount of “0.9” for the detection result of the occupant presence or absence together, thereby calculating the corrected degree of reliability of “0.63.” The output determination unit also multiplies the degree of reliability of “0.8” of the detection result of the physique of the occupant and the degree of vibration influence of “0.6” for the detection result of the physique of the occupant together, thereby calculating the corrected degree of reliability of “0.48.”

The output determination unit 460′ determines, for each of the types of the occupant detection results, whether or not the degree of reliability is greater than or equal to the threshold (step ST145). For example, in the case of changing the degree of reliability of each occupant detection result, the output determination unit 460′ compares the corrected degree of reliability of “0.63” of the detection result of the occupant presence or absence with the threshold of “0.5”, thereby determining that the corrected degree of reliability is greater than or equal to the threshold.

the output determination unit 460′ determines to adopt the detection result of the occupant presence or absence as an occupant detection result (step ST146), when the corresponding one of the degrees of reliability of the respective types of the occupant detection results is greater than or equal to the threshold (when “YES” in step ST145).

The storage control unit 490 stores, in a not-illustrated storage unit, the occupant seat information “left rear seat” and the occupant presence or absence information “presence” which the output determination unit 460′ has determined to adopt. At that time, the storage control unit 490 stores the occupant seat information “left rear seat” and the occupant presence or absence information “presence” while linking them with the occupant identification information outputted from the occupant identification information acquirement unit 470, and, after that, outputs the occupant seat information “left rear seat” and the occupant presence or absence information “presence” to a vehicle-mounted device (step ST20).

When acquiring the occupant detection results and the vibration amount, the degree of influence determination unit 450 uses this vibration amount and the occupant detection results from the occupant detection unit 420, to determine the degree of influence of vibrations as to each of the types of the occupant detection results (step ST30).

After the process of step ST30 is completed, the occupant detection device 400′ proceeds to the processes of step ST40 and the subsequent steps.

In a state where vibrations occur, the occupant detection device 400′ according to Embodiment 2 can output an occupant detection result with a small influence of the vibrations, by taking into consideration the degree of influence which depends on the vibration amount as to each of the types of the occupant detection results. As a result, even when an occupant moves from one seat to another in a state where vibrations occur in the vehicle, the occupant detection device 400′ can output an occupant detection result with few errors caused by the vibrations.

Further, the occupant detection device 400′ according to Embodiment 1 makes it less likely to reduce the degree of reliability of a detection result with a small influence of vibrations, thereby being able to reduce the frequency of erroneous rejection (erroneously rejecting a detection result which is outputted correctly). Further, the degree of reliability of a detection result with a large influence of vibrations is reduced, so that the frequency of erroneous determination can be reduced.

It is to be understood that a free combination of the above-mentioned embodiments can be made, various changes can be made in any component in each of the above-mentioned embodiments, or any component in each of the above-mentioned embodiments can be omitted within the scope of the present disclosure.

### INDUSTRIAL APPLICABILITY

Because the occupant detection device according to the present disclosure can output an occupant detection result with few errors even in a state where vibrations occur, the occupant detection device is suitable for use as an occupant detection device or the like that outputs an occupant detection result to be used for the control of a vehicle.

### REFERENCE SIGNS LIST

1, 1′ occupant detection system, 2 air bag control device, 3 notification device, 4 display device, 100 electric wave sensor (first detection sensor), 200 vibration detection sensor, 300 vehicle-mounted sensor (second detection sensor), 400, 400′ occupant detection device, 410 analysis unit, 420 occupant detection unit, 421 occupant presence or absence determination unit, 422 physique determination unit, 423 posture determination unit, 424 biological information detection unit, 430 vibration amount calculation unit, 440 normalization processing unit, 450 degree of influence determination unit, 460, 460′ output determination unit, 470 occupant identification information acquirement unit, 480 movement detection unit, 490 storage control unit, 1001 occupant, 1101 seat information, 1102 occupant presence or absence information, 1103 physique information, 1104 posture information, 1105 biological information, 1201 type of detection result, 1202 degree of influence, 1203 corrected vibration amount (vibration amount after correction), 2001 processor, 2002 memory, and 2003 processing circuit.

1. An occupant detection device that detects one or more occupants riding in a vehicle, the occupant detection device comprising:
processing circuitry
to output one or more detection results about the respective one or more occupants, each of the one or more detection results being detected using an electric wave, each of the one or more detection results being about a corresponding one of seat positions of the one or more occupants;
to determine whether to adopt or reject the one or more detection results d in accordance with a vibration amount of the vehicle, and to, when the one or more detection results are adopted, output the one or more detection results;
to cause a memory to store the outputted one or more detection results while linking the one or more detection results with the respective seat positions in the vehicle, and to then output the one or more detection results; and
to detect a movement as to each of the one or more occupants detected using a means other than an electric wave, and to output pieces of position information about the respective one or more occupants, wherein
when the processing circuitry detects a movement of one of the one or more occupants in a state where no detection result is outputted, the processing circuitry corrects, using a corresponding one of the pieces of position information about the respective one or more occupants, a link between a corresponding one of the one or more detection results and a corresponding one of the seat positions which are stored in the memory, and then outputs corrected information indicating both the one or more detection results and the seat positions.

2. The occupant detection device according to claim 1, wherein when the vibration amount of the vehicle is greater than or equal to a threshold, the processing circuitry does not output the one or more detection results.

3. The occupant detection device according to claim 1, wherein while the processing circuitry detects a movement of one of the one or more occupants, the processing circuitry does not output the one or more detection results provided.

4. The occupant detection device according to claim 1, wherein each of the one or more detection results provided includes at least one of presence or absence of a corresponding one of the one or more occupants, physique of the corresponding one of the one or more occupants, posture of the corresponding one of the one or more occupants, and biological information.

5. The occupant detection device according to claim 1, wherein
the processing circuitry generates one or more pieces of occupant identification information each indicating both a corresponding one of the one or more occupants detected using the means other than an electric wave, and a seat position detected using the means other than an electric wave,
the processing circuitry causes the memory to store the one or more detection results while linking the one or more detection results with the respective one or more pieces of occupant identification information, and
when the processing circuitry detects that the movement of the one of the one or more occupants is completed, the processing circuitry corrects, using occupant identification information after the movement of the one of the one or more occupants is completed, a link between a corresponding one of the one or more detection results and a corresponding one of the one or more pieces of occupant identification information which are stored in the memory.

6. The occupant detection device according to claim 1, wherein the pieces of position information about the respective one or more occupants result from detecting the one or more occupants and seat positions using at least one of an image capture device, a sound collection device, and a seating pressure sensor.

7. An occupant detection method of detecting one or more occupants riding in a vehicle, the occupant detection method comprising:
outputting one or more detection results about the respective one or more occupants, each of the one or more detection results being detected using an electric wave, each of the one or more detection results being about a corresponding one of seat positions of the one or more occupants;
determining whether to adopt or reject the one or more detection results d in accordance with a vibration amount of the vehicle, and, when the one or more detection results are adopted, outputting the one or more detection results;
causing a memory to store the outputted one or more detection results while linking the one or more detection results with the respective seat positions in the vehicle, and then outputting the one or more detection results;
detecting a movement as to each of the one or more occupants detected using a means other than an electric wave, and outputting pieces of position information about the respective one or more occupants; and
when a movement of one of the one or more occupants is detected in a state where no detection result is outputted, correcting, using a corresponding one of the pieces of position information about the respective one or more occupants, a link between a corresponding one of the one or more detection results and a corresponding one of the seat positions which are stored in the memory, and then outputting corrected information indicating both the one or more detection results and the seat positions.
